(19) United States
(12) Patent Application Publication
(10) Pub. No.: US 2025/0181967 A1
(43) Pub. Date: Jun. 5, 2025

(54) MACHINE-LEARNED SEAT PREDICTION AND ASSIGNMENT

(71) Applicant: Jump Platforms, Inc., Long Beach, CA (US)

(72) Inventors: Joel Resnicow, Seattle, WA (US); Edward Khoury, Glendale, CA (US)

(21) Appl. No.: 18/527,276

(22) Filed: Dec. 2, 2023

(51) Int. Cl. G06N 20/00

(52) U.S. Cl. CPC G06N 20/00

(57) ABSTRACT

The seat assignment server access user historical attendance data for events at a venue during a season of events. Each user is associated with a subscription to the season of events such that a seat at the venue is not assigned for the user until the user arrives at the venue. The seat assignment server then generates a set of training data based on the accessed historical attendance data and trains a machine-learned model using the generated set of training data. The machine-learned model is configured to identify a seat quality based on characteristics and historical attendance data of the user. The seat assignment server receives a request from the user for a seat at the venue for the event when the user arrives at the venue. The seat assignment server assigns a seat at the venue to the user by applying the machine-learned model to characteristics and historical attendance data associated with the user to identify a seat quality and selecting the seat based on the identified seat quality.

### BACKGROUND

Individuals attending an event are generally assigned designated seats in a venue before arriving at the venue, which leaves no room for flexibility or adaptability based on current characteristics of the event. Furthermore, when seats are assigned in advance, event organizers may experience several issues, including wasted or unused seating capacity, reduced user satisfaction, and lower revenue generation. Assigning seats too far in advance can lead to inefficient use of available seating capacity, as individuals may change their plans and not show up to the event, leaving designated seats empty. This results in lower revenue generation and a reduced event experience, as empty seats can negatively impact the atmosphere of the event. Additionally, assigning seats too far in advance may not allow for flexibility in accommodating the changing needs of individuals who require specific seating options or prefer to be seated with a certain group, leading to lower overall satisfaction.

### SUMMARY

The following disclosure describes a seat assignment server that assigns a seat to a user when the user arrives at the venue. In particular, the seat assignment server accesses historical attendance data for a user for events at a venue during a season of events at the venue, the user being associated with a subscription to the season of events such that a seat at the venue is not assigned for the user until the user arrives at the venue, the historical attendance data including at least a historical seat quality of each seat assigned to the user for events attended by the user. The seat assignment server generates a set of training data based on the accessed historical attendance data. The seat assignment server trains a machine-learned model using the generated set of training data to identify a seat quality based on characteristics and historical attendance data of a user. The seat assignment server receives a request from a target user for a seat at the venue for the event when the target user arrives at the venue. The seat assignment server assigns a target seat at the venue to the target user by applying the machine-learned model to characteristics and historical attendance data associated with the target user to identify a target seat quality and selecting the target seat based on the identified target seat quality.

The seat assignment server may assign the target seat at the venue by accessing real-time seat status information for the venue and selecting the target seat for assignment based on the identified target seat quality and the real-time seat status information. The seat assignment server may further modify a user interface of a user device to include information identifying the target seat. The seat assignment server may further update the assigned target seat based on a request of the target user. The seat assignment server may further update the assigned target seat based on a size of a group of individuals attending the event with the target user. The seat assignment server may further update the assigned target seat mid-game based on real-time seat status information for the venue.

The machine learning model may include a regression model, a random forest classifier, a support vector machine, a neural network, or a model trained by an unsupervised approach. The characteristics and historical attendance data of the user may include data indicating demographics of the user, average seat quality assigned to the user at prior events, data associated with an account for the user, data associated with groups and/or individuals who attended prior events with the user, number of games attended by the user, data indicating a user's past seat locations, data indicating a user's seating preferences, arrival times of the user, number of no-shows by the user, data indicating advance notice of event attendance by the user, data associated with historical purchases of the user at prior events, user data indicating user feedback for prior events, data associated with user social media engagement, and data indicating teams, match, rivalry, and game preferences of the user.

The event may be one of a basketball game, a baseball game, a football game, a volleyball game, a soccer game, a tennis match, a hockey game, and a rugby game. The subscription to the season of events may include a fixed number of events or a ticket package.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 illustrates a system environment for a seat assignment server, according to one embodiment.

FIG. 2 is a high-level block diagram illustrating a detailed view of a seat assignment server, according to one embodiment.

FIG. 3 is a flowchart illustrating a process for assigning a seat to a user at a venue, according to one embodiment.

FIG. 4 is a high-level block diagram illustrating physical components of a computer, according to one embodiment.

The figures depict embodiments of the present invention for purposes of illustration only. One skilled in the art will readily recognize from the following description that alternative embodiments of the structures and methods illustrated herein may be employed without departing from the principles of the invention described herein.

### DETAILED DESCRIPTION

The figures and the following description relate to preferred embodiments by way of illustration only. One of skill in the art may recognize alternative embodiments of the structures and methods disclosed herein as viable alternatives that may be employed without departing from the principles of what is disclosed.

Reference will now be made in detail to several embodiments, examples of which are illustrated in the accompanying figures. It is noted that wherever practicable similar or like reference numbers may be used in the figures and may indicate similarity or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Example System Environment

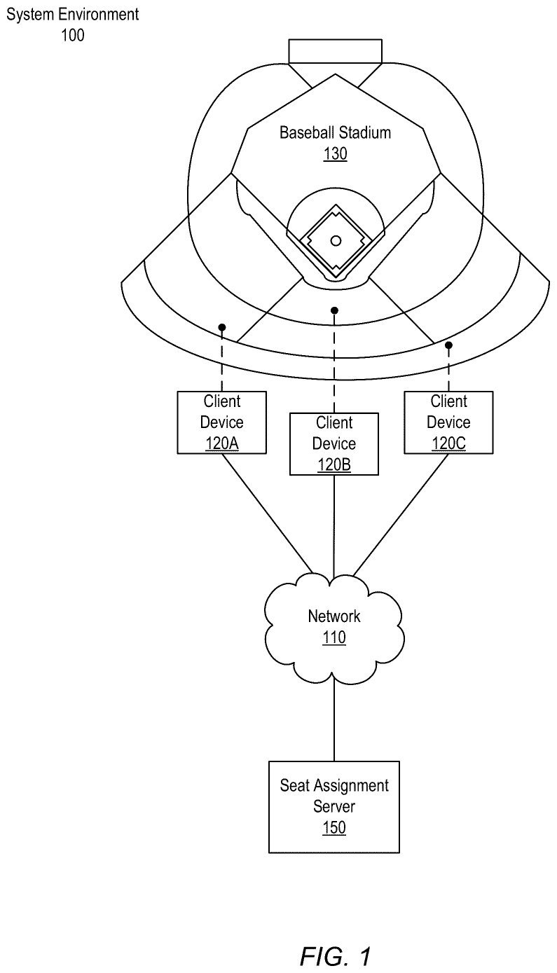

FIG. 1 illustrates a system environment 100 for a seat assignment server 150, according to one embodiment. The seat assignment server 150 is connected to a number of client devices 120 used by attendees at an event via a network 110. These various components are now described in additional detail.

The client devices 120 (i.e., 120A, 120B and 120C) are computing devices such as smart phones, laptop computers, desktop computers, or any other device that can communicate with the seat assignment server 150 via the network 110. The client devices 120 may provide a number of applications, which may require user authentication before a user can use the applications, and the client devices 120 may interact with the seat assignment server 150 via an application. Though three client devices 120 are shown in FIG. 1, any number of client devices 120 may be connected to the seat assignment server 150 in other embodiments. The client devices 120 may be located within a region designated for an event, like a baseball stadium 130. Other designated regions may include theaters, concert halls, courts, fields, and/or any other type of venue for events. For the sake of simplicity, the description herein may be limited to stadiums 130, though in practice, the methods described herein apply equally to any other region or venue.

Furthermore, though the event at the stadium 130 may herein be referred to as a “sporting event” or “baseball game,” the event may be related to other visual or auditory shows, conferences, or meetings. Examples of such events include football games, basketball games, tennis matches, golf tournaments, and/or another sporting event. Other examples of such events include movies, concerts, musicals, plays, academic conferences, talk shows, and the like.

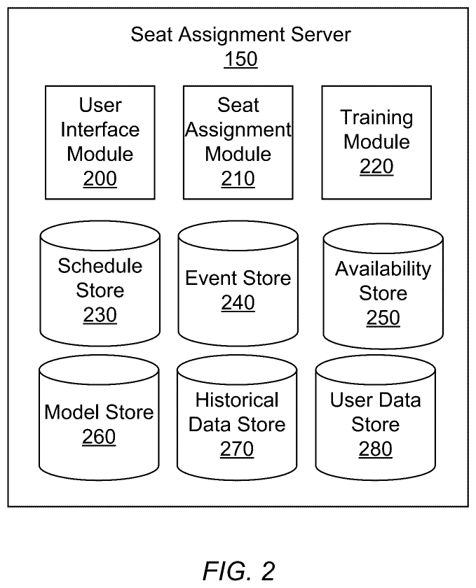

The network 110 connects the client devices 120 to the seat assignment server 150, which is further described in relation to FIG. 2. The network 110 may be any suitable communications network for data transmission. In an embodiment such as that illustrated in FIG. 1, the network 110 uses standard communications technologies and/or protocols and can include the Internet. In another embodiment, the network 110 use custom and/or dedicated data communications technologies.

### Example Computing Server Architecture

FIG. 2 is a high-level block diagram illustrating a detailed view of a seat assignment server 150, according to one embodiment. The seat assignment server 150 operates to assign seats for an event when a user (for e.g., an attendee, a guest, a group of individuals, etc.) arrives at a venue.

In one particular embodiment, the seat assignment server 150 accesses historical attendance data for a user for events at a venue during a season of events at the venue, the user being associated with a subscription to the season of events such that a seat at the venue is not assigned for the user until the user arrives at the venue, the historical attendance data including at least a historical seat quality of each seat assigned to the user for events attended by the user. The seat assignment server 150 generates a set of training data based on the accessed historical attendance data. The seat assignment server 150 trains a machine-learned model using the generated set of training data to identify a seat quality based on characteristics and historical attendance data of a user. The seat assignment server 150 receives a request from a target user for a seat at the venue for the event when the target user arrives at the venue. The seat assignment server 150 assigns a target seat at the venue to the target user by applying the machine-learned model to characteristics and historical attendance data associated with the target user to identify a target seat quality and selecting the target seat based on the identified target seat quality.

Accordingly, a user may be associated with a subscription to a season of events such that a seat at the venue is not assigned for the user until the user arrives at the venue. The subscription to the season of events can be a fixed number of events or a ticket package. For example, the event can be a basketball game, a baseball game, a football game, a volleyball game, a soccer game, a tennis match, a hockey game, or a rugby game. For example, the user can hold season tickets for a basketball league.

The assignment of a seat when the user arrives at the venue can offer certain benefits compared to reserved seating. These benefits may include a personalized seating experience, a dynamic seat optimization, an efficient venue utilization, increased customer loyalty, enhanced adaptability, and an incentive for consistent attendance. For example, analyzing historical attendance data can help identify seat qualities preferred by the user. This information can be used to select and assign the most suitable seats, enhancing the user's overall experience and ensuring that they receive a consistently enjoyable seating arrangement throughout the season.

As user's preferences might change over time, analyzing their historical attendance data regularly allows dynamic seat optimization, providing more accurate and up-to-date seating assignments tailored to their evolving preferences. For example, as seats are assigned upon arrival, the venue can make necessary adjustments and optimize seating based on factors such as the user's arrival time, the user's guests, seating availability, and prior preferences. This approach allows for more flexible and adaptable seat assignments, thus enhancing the overall experience. For example, personalized seating assignments show appreciation for valued season ticket holders by catering to their preferences. This process may encourage customer loyalty, leading to increased retention and a higher likelihood of ticket renewals for the next season. Personalized seat assignments can serve as an incentive for season ticket holders to attend events more consistently, as they know their seating experience will both cater to their preferences and potentially improve with each event.

Assignment of seat on arrival further provides efficient venue utilization, which can minimize empty seats and potentially allow for better distribution of attendees throughout the venue, providing a fuller and more engaging atmosphere. With seat assignments made upon arrival, venues can adapt more easily to any unexpected changes that might occur, such as an attendee's unique requirements or situation affecting seat availability.

A seat is a designated space within the venue where the attendee is permitted to occupy during the event, or can sit to enjoy an event. Seats can be arranged in rows and/or sections to provide an organized and orderly layout, ensuring that all attendees have a specific place to enjoy the event. They may come in various forms, such as chairs, benches, or bleachers, depending on the venue type and the event taking place.

Seat quality refers to the perceived value, comfort, and overall experience associated with a particular seat in a venue. Seat quality is a crucial aspect of an attendee's overall experience at a venue, as it greatly influences their comfort, enjoyment, and satisfaction. Several factors contribute to seat quality, including the view, which encompasses the seat's line of sight, viewing angle, elevation, and any potential obstructions. Proximity to the stage or playing field also plays a role, with closer seats typically viewed as more desirable. Acoustics could be essential, as the audio experience affects how individuals perceive a performance or event. Comfort, including seat design, padding, legroom, and spaciousness, directly impacts the attendee's well-being. Accessibility is crucial in allowing attendees to reach their seats easily and safely through various access points. Amenities, such as proximity to restrooms, concession stands, and exits, further contribute to the overall seat quality and help enhance the attendee experience at the event.

In one aspect, to measure seat quality, a scoring system can be developed ranging from 1 (lowest) to 5 (highest) for factors like view, proximity, acoustics, comfort, accessibility, and amenities. Scores can be assigned based on the quality of each factor. The individual scores can be added and the sum can be divided by the total number of factors, resulting in a comprehensive average score, representing the seat quality. This metric may allow for easy comparison and assessment of seating options in a venue.

Once a score has been assigned to the seats at the venue, seat quality can be understood as the metric that reflects the overall experience and desirability of a particular seat for an attendee. This score could consider the above-mentioned factors such as view, proximity to the stage or field, acoustics, comfort, accessibility, and amenities. A higher score indicates a more favorable seating experience, while a lower score signifies a less desirable seating option. This pre-determined seat quality metric makes it easy for event organizers, venue operators, and attendees to compare and select the best seating options based on their preferences, optimizing the overall event experience.

For example, in a basketball game event, courtside seats typically have higher scores for view (5), proximity (5), acoustics (5), and amenities (4) due to their prime location. However, their comfort (4) and accessibility (3) scores may be affected by limited legroom and navigating crowds. On the other hand, back row seats may have lower scores for view (2) and proximity (1) but offer relatively easy accessibility (4) and average scores for acoustics (3), comfort (3), and amenities (3). These examples serve as a general comparison, but scores may vary based on specific venues and personal preferences. It is noted that other scoring systems can be used to measure seat quality.

Referring back to FIG. 2, the seat assignment server 150 includes a user interface module 200, a seat module 210, a training module 220, a schedule store 230, an event store 240, an availability store 250, a model store 260, a historical data store 270, and a user data store 280. In some embodiments, the seat assignment server 150 may include more modules or models than shown in FIG. 2 or one or more of the modules and models shown in FIG. 2 may be combined within the seat assignment server.

The user interface module 200 generates interfaces for display on client devices 120. For example, the user interface module 200 can receive from a client device 120 a request to view tickets for an event, which may be scheduled to occur at a later time or date, or which may be currently occurring. The user interface module 200 receives from the client device 120 a request from a user for a seat assignment when the user arrives at the venue. The user interface module 200 requests seat assignments for the sporting event from the seat assignment module 210. The user interface module 200 generates an interface offering seat assignment upon arrival for the sporting event and transmits the interface for display via the client device 120. The interface may include interactive elements which the user may interact with to receive information, request assignment of seats, or receive seat assignments. The interface may include interactive elements which the user may interact with to request an update of the assigned seat(s). For example, the user may request an update of the assigned seat(s) based on a size of a group of individuals attending the event with the user. The user may also request an update of the assigned seat(s) mid-game based on real-time seat status information for the venue.

The user interface module 200 may also retrieve schedule information for the event from schedule store 230. The schedule information for the event includes a date of the event, an estimated time range of the event, and a location of the event (i.e., a stadium), and the user interface module 200 may display the schedule information to the interface. The user interface module 200 may display the schedule information to the interface for users to view as they browse tickets and seat availability for the sporting event.

The user interface module 200 further receives requests for tickets from client devices 120 via the interface and facilitates purchases of the tickets via the interface. For each purchased ticket, the user interface module 200 may indicate that the ticket was sold to the ticket module 210 and generate a ticket interface showing an electronic, scannable ticket for admission at the event.

As seat assignment occurs upon arrival at the venue, the ticket is not for a particular seat in the venue or a section of the venue. The interface may also include an interactive map of the stadium, event information retrieved from the event store 240. For example, while at the event, the user may display the interface to a scanner system or teller to gain entrance to the event. Furthermore, users may interact with the interface to indicate that they are at their assigned seat or that they would like to surrender their assigned seat when they leave the sporting event before its conclusion.

In one embodiment, the training module 220 can access characteristic data and historical attendance data for the user for events at a venue during a season of events at the venue. Data indicating historical attendance of a user are stored in the historical data store 270. Data indicating characteristics of a user are stored in the user data store 280. For example, data including characteristics and historical attendance data of season ticket holders can include: data indicating demographics of the user; average seat quality assigned to the user at prior events; data associated with an account for the user; data associated with groups and/or individuals who attended prior events with the user; number of games attended by the user; data indicating a user's past seat locations; data indicating a user's seating preferences; arrival times of the user; number of no-shows by the user; data indicating advance notice of event attendance by the user; data associated with historical purchases of the user at prior events; user data indicating user feedback for prior events; data associated with user social media engagement; and data indicating teams, match, rivalry, and game preferences of the user.

User demographic data may be a factor to identify a personalized seat quality and enhance the overall event experience of the user. The data pertains to characteristics such as age, gender, location, income, education level, and occupation, that can help better understand users' preferences and priorities. For instance, demographic data could be used to identify preferred seating arrangements for users based on their age, income, or location. If an event is targeted towards an older demographic, seat quality factors such as comfort or accessibility may be prioritized. Similarly, if the event caters to professionals, premium seating options may be more appealing. By analyzing demographic data alongside other metrics, such as historical attendance data, a machine learning algorithm can recommend seat assignments that cater to individual preferences and provide a personalized seating experience. Ultimately, this could lead to increased customer satisfaction and encourages continued attendance to future events.

Average seat quality assigned to the user at prior events may be a factor to identify a personalized seat quality for future events. This data pertains to the user's historical attendance data, including the quality of seats that they were previously assigned for events attended in the past. For example, if a user consistently receives high-quality seats close to the stage or field, the system may recommend similar seats for future events based on that preference. Similarly, if a user has shown a preference for premium seating areas in previous events, the system may prioritize those seat options for future events.

Data associated with a user account, such as their purchase history and membership status, can be used to provide a personalized seat quality for events. By analyzing this data, the system may recommend seating options that cater to the user's preferences and status. For example, if a user has a VIP membership, the system may consider assigning them to premium seating options with additional amenities. Similarly, if the user has consistently purchased tickets for a specific team or events, the system may recommend seating arrangements that cater to their preferences. This data can help event organizers reward loyal customers and influence future purchasing decisions by providing seating options that maximize user satisfaction and experience.

Data associated with groups and/or individuals who attended previous events with the user can be used to provide a personalized seat quality by identifying seating arrangements that cater to group needs. By analyzing this data, the system can identify common seating preferences or requirements amongst group members and generate a seating arrangement that satisfies all members' preferences. For example, if the user has repeatedly attended events with a group that requires additional legroom due to height, the system can recommend seating options that provide ample legroom for all members. Similarly, if a user regularly attends events with family members, the algorithm may recommend seating arrangements that include adjacent seating for family members to enhance the overall event experience. This data can help event organizers maximize customer satisfaction by delivering optimized seating arrangements that cater to the preferences of multiple individuals with varying needs.

The number of games attended by the user can be a factor that can be used to provide a personalized seat quality for events. By analyzing this data, the system can identify patterns and preferences associated with the frequency of attendance. For example, if a user has attended many events, the algorithm may prioritize seating options that have not been assigned before to offer new experiences. At the same time, if a user has a low attendance rate, the algorithm may prioritize high-quality seating options closer to the stage or field to inspire them to return for future events. This data can help event organizers optimize seating arrangements to maximize customer satisfaction and encourage attendance.

Data indicating a user's past seat locations is a factor that can be leveraged to provide a personalized seat quality for events. This data can help to identify seating arrangements preferred by the user based on their past experience and satisfaction levels. For instance, if a user prefers seats closer to a particular aisle or section, the system may recommend similar seating arrangements in the future. If a user consistently prefers specific seating areas such as mid-level at a stadium or left-hand side seats in a theater, the system can prioritize seat options accordingly. This data can help event organizers deliver an event experience tailored to the user's preferences, ultimately increasing customer satisfaction and loyalty.

Data indicating a user's seating preferences can be used to provide a personalized seat quality for events. This data helps to identify the specific attributes or characteristics that the user prioritizes when it comes to seating arrangements. For example, if a user consistently prefers to be seated closer to the stage or field, the system may prioritize seating options that offer a direct and clear view of the event's main attraction. Similarly, if a user prefers seats with ample legroom or with particular amenities like a nearby restroom, the system may prioritize seating arrangements that fulfill those preferences. By understanding user preferences, event organizers can assign seats that maximize customer satisfaction and provide a personalized event experience.

Arrival times of the user is a factor that can be leveraged to identify a personalized seat quality. By analyzing this data, the system can identify seating arrangements that allow users to arrive just a few minutes before the start of an event or those that plan to arrive early to get the best seat possible. For instance, if a user consistently arrives early to events, the system may prioritize seat assignments that offer an optimal view from their preferred seating area. Conversely, if a user frequently arrives just moments before the event starts, the system may prioritize seat assignments closer to the entrance or that offer easier accessibility. This data can help event organizers deliver an event experience that caters to each user's unique needs, providing an excellent overall event experience and increasing customer satisfaction.

The number of no-shows by the user is a factor that can be used to identify a personalized seat quality. By analyzing this data, the system can identify user preferences that may have contributed to no-shows in the past. For example, if a user misses events due to discomfort or a poorly located seat, the system may prioritize a specific seating area or select arrangements with amenities such as additional legroom or more significant spaces. Similarly, if a user tends to miss events due to accessibility, the system may prioritize seating assignments near accessible entrances or offer more accessible seating options. This data can help event organizers optimize seating arrangements to maximize customer attendance, provide a better overall event experience, and increase customer satisfaction.

Data indicating advance notice of event attendance by the user is a factor that can be used to identify personalized seat quality. By analyzing this data, the system can identify seating arrangements that cater to a user's specific needs and preferences when they provide advance notice of their event attendance. For example, if a user provides advance notice for an event, the system may prioritize seating assignments near the entrance with higher levels of comfort or special amenities. Similarly, if a user requires priority seating arrangements, the system may recommend personalized seating options with enhanced amenities to provide a better experience. This data can help event organizers optimize seating arrangements to meet the unique requirements of the attendee, providing a personalized experience, and increasing customer retention.

Data associated with historical purchases of a user at prior events can be a significant factor in identifying personalized seat quality. By analyzing past purchase patterns, the system can determine the preferences and priorities of the user when attending events. For instance, if a user has frequently purchased food and beverages during past events, the system may prioritize seating assignments that are closer to concession stands to cater to their preferences. Similarly, if a user has consistently opted for premium seating with additional amenities, the system may prioritize similar seating options for future events. This personalized and data-driven approach allows for an enhanced event experience that caters to the user's unique needs, ultimately resulting in higher customer satisfaction.

User feedback data from prior events can be a factor in identifying personalized seat quality. By examining user reviews and feedback, the system can gain insights into specific aspects of seating arrangements that were either appreciated or disliked by the user. For example, if a user's feedback highlighted dissatisfaction with seats that had limited legroom during previous events, the system could prioritize seating options with more spacious legroom for the user's future events, ensuring enhanced comfort. Conversely, positive feedback on specific seating areas or amenities could guide the system to select similar options for the user in subsequent events. By utilizing user feedback data, seat assignment can be tailored to users' needs and preferences, thus offering a more satisfying event experience.

Data associated with user social media engagement can play a role in identifying personalized seat quality. By monitoring users' interactions, likes, and mentions on social media platforms, the system can develop insights into their event preferences and inclinations. For example, suppose a user frequently shares photos and mentions their fondness for sitting near a specific area in a venue, such as close to the stage or behind the player's bench. In that case, the system can prioritize similar seating arrangements in their future events to cater to their preferences. Social media engagement data enables the system to better understand user preferences, further customizing seat assignments to maximize event enjoyment and overall satisfaction.

Data indicating a user's preferences for teams, matches, rivalries, and games can greatly contribute to identifying personalized seat quality. By analyzing this data, the system can gain insights into seating arrangements that would be most appealing to the user during specific events. For example, if a user demonstrates a preference for watching high-intensity rivalry games, the system may prioritize seating options that provide an engaging atmosphere, such as closer to the field or in sections with a more energetic crowd. This data-driven approach ensures that the seat assignments align with the user's preferences during significant events, offering a more satisfying and immersive event experience tailored to their interests.

The training module 220 can generate a set of training data based on the accessed data stored in the historical data store 270 and the user data store 280. In one aspect, the training module 220 can further process the accessed data to extract relevant features and patterns that can be used as input for a machine learning model. This step may also involve data transformation, normalization, and/or dealing with any missing or incomplete data points. All of the above description of data indicating the personalized seat quality can be used to train the machine learning model, can be used as inputs to the machine learning model, and that the output of the machine learning model can account for this.

The training module 220 can train the machine learning model (for e.g., random forests, support vector machines, or deep learning models) using the accessed data and/or processed data. The model learns to find correlations in the data in order to identify a seat quality for seats at the venue. The training module 220 may test the model's performance on a separate dataset, identifying its accuracy in predicting seat quality for users. The training module 220 may adjust and fine-tune the model as needed to improve its predictive capability.

The model trained by the training module 220 may be stored in the model store 260. The model returns a score that indicates a seat quality for the seats at the venue. For example, the model can make personalized predictions about the seat quality score that would be most suitable for a particular user. By considering individual preferences and historical data, the model can provide tailored seat quality scores for each user, optimizing the overall experience and satisfaction of event attendees. In one aspect, with a seat quality machine learning model in place for season ticket holders, the model uses each user's characteristics and historical attendance data to provide a personalized seating experience. By analyzing user preferences and past behavior, the model dynamically optimizes seat assignments upon arrival, leading to efficient venue utilization and enhanced adaptability to last-minute changes. This data-driven approach caters to individual preferences, increasing customer loyalty, and incentivizes consistent attendance throughout the season. By delivering tailored seat assignments that account for each attendee's unique requirements, the model improves the overall event experience while ensuring the best use of the venue's available seating.

The seat assignment module 210 can access and retrieve the model trained by the training module 220. The seat assignment module 210 assigns a seat at the venue to the user by applying the model to characteristics and historical attendance data associated with the user to identify the seat quality and selecting the target seat based on the identified target seat quality.

In one aspect, the seat assignment module 210 assigns a seat at the venue to a user by accessing real-time seat status information for the venue and selecting a target seat for a user based on the identified target seat quality and the real-time seat status information. The availability store 250 stores real-time seat status information including available (e.g., unassigned) and unavailable (e.g., assigned) seats within each section of the venue. In assigning a seat to the user, the seat assignment module 210 can access the availability store 250 to determine which seats are available. Then, the seat assignment module 210 may select, amongst the available seats, a seat or a set of seats that provides a personalized seating experience to the user based on the identified target seat quality associated with the user.

The seat assignment module 210 can cause the user interface module 200 to modify an interface on client devices 120 to include information identifying a seat for a user after a seat has been assigned. The seat assignment module 210 can also update a seat assigned to a user based on a request of the user. The seat assignment module 210 can update a seat assigned to a user based on a size of a group of individuals attending the event with the user. The seat assignment module 210 can further update the assigned seat mid-game based in part on real-time seat status information for the venue. In particular, the seat assignment module 210 can upgrade seats mid-game to optimize seating capacity and enhance the event experience. In a scenario where there are 200 seats but only 100 people attend, the seat assignment module 210 can leverage real-time data and user preferences to assign individuals to higher-quality seating arrangements that were previously unavailable. For example, if the seat assignment module 210 detects that certain high-quality seats closer to the field or court are vacant and individuals have expressed a preference for those seats, it can upgrade their seating arrangement mid-game to improve their viewing experience and enhance overall satisfaction. This dynamic approach to seat assignment ensures efficient seating capacity utilization and maximizes the overall event experience.

The updates as mentioned in the present disclosure can occur based on a request of the user. The user can make the update requests via an interface of the user interface module 200.

In one aspect, if a user does not attend games very often, the average seat quality assigned to the user by the seat assignment module 210 may be higher on a per-game basis. The term “often” in this context may depend on various factors such as the number of events in the season or the frequency of events held by the venue. However, in general, the term refers to a user attending fewer events throughout the season. For example, if a venue holds 20 events in a season, a user who attends only one or two events may be considered as someone who does not attend games very often. Similarly, a user who attends five events may still be considered to attend games less often than someone who attends 15 events in the same season.

For example, when a user attends fewer games throughout the season, they may be assigned a higher quality seat on a per-game basis as a reward for their loyalty and interest in attending the event. This is because the system may assume that the user is likely to value the limited number of games they attend and therefore assign them a better seat. This personalized approach to seat assignment aims to increase customer satisfaction and loyalty while optimizing the seating capacity of the venue.

In one aspect, the seat assignment module 210 can assign to a user a very high quality seat (much higher than the average quality) once or twice per season as a reward for their loyalty and interest in attending the events. This approach ensures that the prediction model is up-to-date and considers the recent seat assignments of each user. Additionally, it allows the system to deliver a personalized and optimized experience for each user, which maximizes customer satisfaction and encourages continued attendance to future events.

### Example Seat Assignment Process

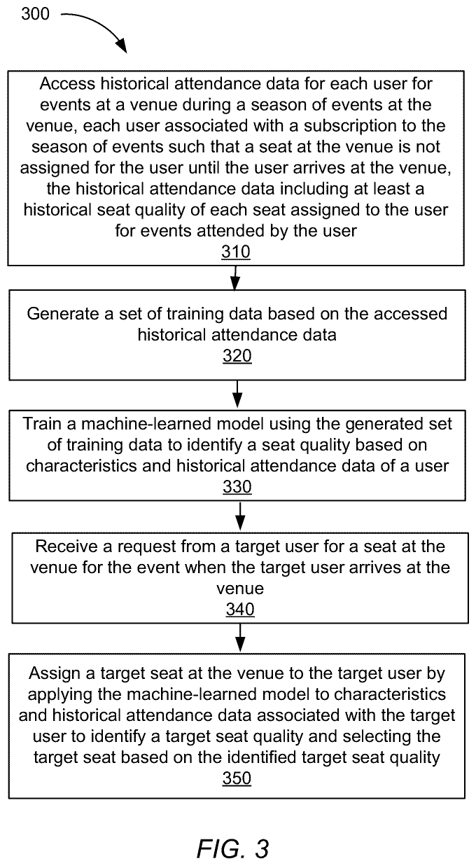

FIG. 3 is a flowchart illustrating a process 300 for assigning a seat to a user at a venue. Though reference is made to the seat assignment server 150 for this process 300, the process can be used by other online systems or mobile applications.

The training module 220 accesses 310 accesses historical attendance data for each user for events at a venue during a season of events at the venue. Each user is associated with a subscription to the season of events such that a seat at the venue is not assigned for the user until the user arrives at the venue. The historical attendance data includes at least a historical seat quality of each seat assigned to the user for events attended by the user. In one aspect, the event is one of a basketball game, a baseball game, a football game, a volleyball game, a soccer game, a tennis match, a hockey game, and a rugby game. The subscription to the season of events can include a fixed number of events or a ticket package.

The training module 220 generates 320 a set of training data based on the accessed historical attendance data.

The training module 220 trains 330 a machine-learned model using the generated set of training data to identify a seat quality based on characteristics and historical attendance data of a user. The machine-learned model may include a regression model, a random forest classifier, a support vector machine, a neural network, or a model trained by an unsupervised approach. The characteristics and historical attendance data of the user may include: data indicating demographics of the user; average seat quality assigned to the user at prior events; data associated with an account for the user; data associated with groups and/or individuals who attended prior events with the user; number of games attended by the user; number of no-shows by the user; data indicating advance notice of event attendance by the user; data associated with historical purchases of the user at prior events; user data indicating user feedback for prior events; data associated with user social media engagement; and data indicating teams, match, rivalry, and game preferences of the user.

The seat assignment module 210 receives 340 a request from a target user for a seat at the venue for the event when the target user arrives at the venue.

The seat assignment module 210 assigns 350 a target seat at the venue to the target user by applying the machine-learned model to characteristics and historical attendance data associated with the target user to identify a target seat quality and selecting the target seat based on the identified target seat quality. For example, the seat assignment module 210 may assign the target seat at the venue by accessing real-time seat status information for the venue and selecting the target seat for assignment based on the identified target seat quality and the real-time seat status information.

The seat assignment module 210 may update the assigned target seat based on a request of the target user. The seat assignment module 210 may update the assigned target seat based on a size of a group of individuals attending the event with the target user. The seat assignment module 210 may update the assigned target seat mid-game based on real-time seat status information for the venue. In one aspect, the user interface module 200 may modify a user interface of a user device to include information identifying the target seat.

The seat assignment module 210 as described in the present disclosure offers numerous advantages to both users and venue managers by providing an optimized, personalized seating experience. It utilizes data points such as seat preferences, accessibility, view angles, and distance from amenities to create a tailored, efficient seating assignment when a user arrives at the venue. For instance, when a sports fan attends a basketball game, the seat assignment module considers the fan's favorite team, height, and preference for being near refreshments. Accordingly, it selects a seat with an optimal vantage point for watching the game, considering the vision lines for someone their height while retaining proximity to concession stands. This streamlined process significantly enhances the customer experience and ensures attendees have a positive experience in the venue, fostering continued patronage and user satisfaction.

### Computing Machine Architecture

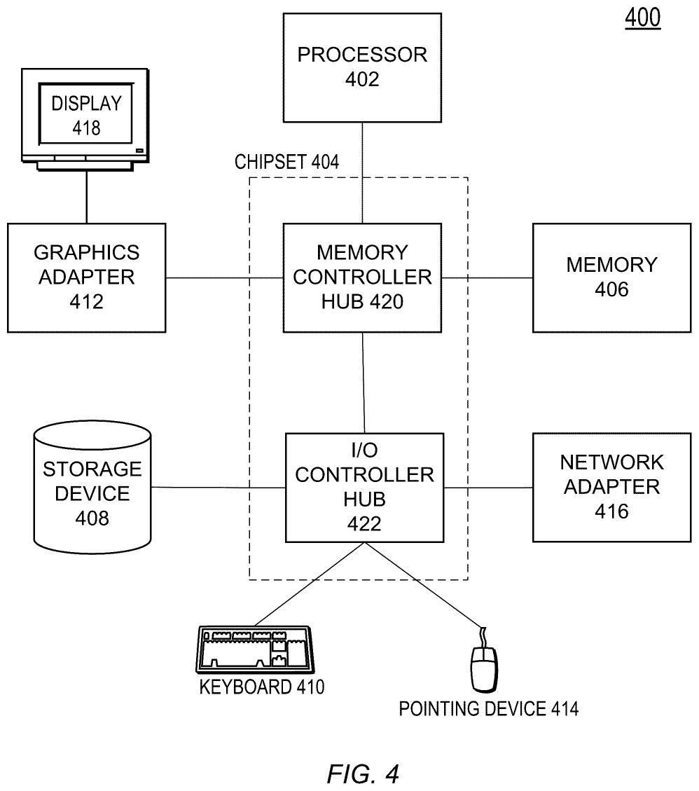

FIG. 4 is a high-level block diagram illustrating physical components of a computer, according to one embodiment. Illustrated are at least one processor 402 coupled to a chipset 404. Also coupled to the chipset 404 are a memory 406, a storage device 408, a graphics adapter 412, and a network adapter 416. A display 418 is coupled to the graphics adapter 412. In one embodiment, the functionality of the chipset 404 is provided by a memory controller hub 420 and an I/O controller hub 422. In another embodiment, the memory 406 is coupled directly to the processor 402 instead of the chipset 404.

The storage device 408 is any non-transitory computer-readable storage medium, such as a hard drive, compact disk read-only memory (CD-ROM), DVD, or a solid-state memory device. The memory 406 holds instructions and data used by the processor 402. The graphics adapter 412 displays images and other information on the display 418. The network adapter 416 couples the computer 400 to a local or wide area network.

As is known in the art, a computer 400 can have different and/or other components than those shown in FIG. 4. In addition, the computer 400 can lack certain illustrated components. In one embodiment, a computer 400 acting as a server may lack a graphics adapter 412, and/or display 418, as well as a keyboard or pointing device. Moreover, the storage device 408 can be local and/or remote from the computer 400 (such as embodied within a storage area network (SAN)).

As is known in the art, the computer 400 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 408, loaded into the memory 406, and executed by the processor 402.

Embodiments of the entities described herein can include other and/or different modules than the ones described here. In addition, the functionality attributed to the modules can be performed by other or different modules in other embodiments. Moreover, this description occasionally omits the term “module” for purposes of clarity and convenience.

### OTHER CONSIDERATIONS

The present subject matter has been described in particular detail with respect to one possible embodiment. Those of skill in the art will appreciate that the present subject matter may be practiced in other embodiments. First, the particular naming of the components and variables, capitalization of terms, the attributes, data structures, or any other programming or structural aspect is not mandatory or significant, and the mechanisms that implement the invention or its features may have different names, formats, or protocols. Also, the particular division of functionality between the various system components described herein is merely for purposes of example, and is not mandatory; functions performed by a single system component may instead be performed by multiple components, and functions performed by multiple components may instead performed by a single component.

Some portions of above description present the features of the present subject matter in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present subject matter include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present subject matter also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMs), EPROMS, EEPROMs, magnetic or optical cards, application specific integrated circuits (ASICs), or any type of computer-readable storage medium suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, the present subject matter is not described with reference to any particular programming language. It is appreciated that a variety of programming languages may be used to implement the teachings of the present subject matter as described herein, and any references to specific languages are provided for invention of enablement and best mode of the present subject matter.

The present subject matter is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the present disclosure is intended to be illustrative, but not limiting, of the scope of the invention, which is set forth in the following claims.

What is claimed is:

1. A computer-implemented method comprising:
accessing, for a set of users, historical attendance data for each user for events at a venue during a season of events at the venue, each user associated with a subscription to the season of events such that a seat at the venue is not assigned for the user until the user arrives at the venue, the historical attendance data comprising at least a historical seat quality of each seat assigned to the user for events attended by the user;
generating a set of training data based on the accessed historical attendance data;
training a machine-learned model using the generated set of training data, the machine-learned model configured to identify a seat quality based on characteristics and historical attendance data of a user;
receiving a request from a target user for a seat at the venue for the event when the target user arrives at the venue; and
assigning a target seat at the venue to the target user by applying the machine-learned model to characteristics and historical attendance data associated with the target user to identify a target seat quality and selecting the target seat based on the identified target seat quality.

2. The computer-implemented method of claim 1, wherein assigning the target seat at the venue further comprises:
accessing real-time seat status information for the venue; and
selecting the target seat for assignment based on the identified target seat quality and the real-time seat status information.

3. The computer-implemented method of claim 1, further comprising modifying a user interface of a user device to include information identifying the target seat.

4. The computer-implemented method of claim 1, further comprising updating the assigned target seat based on a request of the target user.

5. The computer-implemented method of claim 1, further comprising updating the assigned target seat based on a size of a group of individuals attending the event with the target user.

6. The computer-implemented method of claim 1, further comprising updating the assigned target seat mid-game based on real-time seat status information for the venue.

7. The computer-implemented method of claim 1, wherein the machine learning model comprises a regression model, a random forest classifier, a support vector machine, a neural network, or a model trained by an unsupervised approach.

8. The computer-implemented method of claim 1, wherein the characteristics and historical attendance data of the user comprises:
data indicating demographics of the user;
average seat quality assigned to the user at prior events;
data associated with an account for the user;
data associated with groups and/or individuals who attended prior events with the user;
number of games attended by the user;
data indicating a user's past seat locations;
data indicating a user's seating preferences;
arrival times of the user;
number of no-shows by the user;
data indicating advance notice of event attendance by the user;
data associated with historical purchases of the user at prior events;
user data indicating user feedback for prior events;
data associated with user social media engagement; and
data indicating teams, match, rivalry, and game preferences of the user.

9. The computer-implemented method of claim 1, wherein the event is one of a basketball game, a baseball game, a football game, a volleyball game, a soccer game, a tennis match, a hockey game, and a rugby game.

10. The computer-implemented method of claim 1, wherein the subscription to the season of events comprises a fixed number of events or a ticket package.

11. A non-transitory computer-readable storage medium comprising instructions executable by a processor, the instructions comprising:
instructions for accessing, for a set of users, historical attendance data for each user for events at a venue during a season of events at the venue, each user associated with a subscription to the season of events such that a seat at the venue is not assigned for the user until the user arrives at the venue, the historical attendance data comprising at least a historical seat quality of each seat assigned to the user for events attended by the user;
instructions for generating a set of training data based on the accessed historical attendance data;
instructions for training a machine-learned model using the generated set of training data, the machine-learned model configured to identify a seat quality based on characteristics and historical attendance data of a user;
instructions for receiving a request from a target user for a seat at the venue for the event when the target user arrives at the venue; and
instructions for assigning a target seat at the venue to the target user by applying the machine-learned model to characteristics and historical attendance data associated with the target user to identify a target seat quality and selecting the target seat based on the identified target seat quality.

12. The non-transitory computer-readable storage medium of claim 11, wherein the instructions for assigning the target seat at the venue further comprise:
instructions for accessing real-time seat status information for the venue; and
instructions for selecting the target seat for assignment based on the identified target seat quality and the real-time seat status information.

13. The non-transitory computer-readable storage medium of claim 11, further comprising instructions for modifying a user interface of a user device to include information identifying the target seat.

14. The non-transitory computer-readable storage medium of claim 11, further comprising instructions for updating the assigned target seat based on a request of the target user.

15. The non-transitory computer-readable storage medium of claim 11, further comprising instructions for updating the assigned target seat based on a size of a group of individuals attending the event with the target user.

16. The non-transitory computer-readable storage medium of claim 11, further comprising instructions for updating the assigned target seat mid-game based on real-time seat status information for the venue.

17. The non-transitory computer-readable storage medium of claim 11, wherein the machine learning model comprises a regression model, a random forest classifier, a support vector machine, a neural network, or a model trained by an unsupervised approach.

18. The non-transitory computer-readable storage medium of claim 11, wherein the characteristics and historical attendance data of the user comprises:
data indicating demographics of the user;
average seat quality assigned to the user at prior events;
data associated with an account for the user;
data associated with groups and/or individuals who attended prior events with the user;
number of games attended by the user;
data indicating a user's past seat locations;
data indicating a user's seating preferences;
arrival times of the user;
number of no-shows by the user;
data indicating advance notice of event attendance by the user;
data associated with historical purchases of the user at prior events;
user data indicating user feedback for prior events;
data associated with user social media engagement; and
data indicating teams, match, rivalry, and game preferences of the user.

19. The non-transitory computer-readable storage medium of claim 11, wherein the event is one of a basketball game, a baseball game, a football game, a volleyball game, a soccer game, a tennis match, a hockey game, and a rugby game.

20. A computer system comprising:
a computer processor; and
a non-transitory computer-readable storage medium storage instructions that when executed by the computer processor perform actions comprising:
accessing, for a set of users, historical attendance data for each user for events at a venue during a season of events at the venue, each user associated with a subscription to the season of events such that a seat at the venue is not assigned for the user until the user arrives at the venue, the historical attendance data comprising at least a historical seat quality of each seat assigned to the user for events attended by the user;
generating a set of training data based on the accessed historical attendance data;
training a machine-learned model using the generated set of training data, the machine-learned model configured to identify a seat quality based on characteristics and historical attendance data of a user;
receiving a request from a target user for a seat at the venue for the event when the target user arrives at the venue; and
assigning a target seat at the venue to the target user by applying the machine-learned model to characteristics and historical attendance data associated with the target user to identify a target seat quality and selecting the target seat based on the identified target seat quality.
